(19) United States
(12) Patent Application Publication
(10) Pub. No.: US 2010/0275705 A1
(43) Pub. Date: Nov. 4, 2010

(54) ROTOR ASSEMBLY HAVING INTEGRAL DAMPING MEMBER FOR DEPLOYMENT WITHIN MOMENTUM CONTROL DEVICE

(75) Inventor: Theodis Johnson, Litchfield Park, AZ (US)

Correspondence Address: HONEYWELL/IFL;Patent Services, 101 Columbia Road, P.O.Box 2245, Morristown, NJ, 07962-2245, US

(73) Assignee: HONEYWELL INTERNATIONAL INC., Morristown, NJ (US)

(21) Appl. No.: 12/433,726

(22) Filed: Apr. 30, 2009

(51) Int. Cl. G01C 19/06

(52) U.S. Cl. 74/5.5

(57) ABSTRACT

A rotor assembly is provided for deployment within a momentum control device including a rotor assembly housing. In one embodiment, the rotor assembly includes a rotor shaft rotatably mounted within the rotor assembly housing, a floating bearing cartridge disposed around a first end portion of the rotor shaft, and a radially-compliant damping member. The radially-compliant damping member is mechanically coupled between the floating bearing cartridge and the rotor assembly housing, as taken along an emitted disturbance path. The radially-compliant damping member reduces the transmission of vibratory forces from the floating bearing cartridge to the rotor assembly housing to reduce emitted disturbances during operation of the momentum control device.

### TECHNICAL FIELD

The present invention relates generally to momentum control devices, such as reaction wheels and control moment gyroscopes; and, more particularly, to a rotor assembly having at least one integral damping member suitable for deployment within a momentum control device.

### BACKGROUND

Momentum control devices, most notably control moment gyroscopes and reaction wheels, are commonly deployed aboard spacecraft (and certain other vehicles) within attitude control systems. A generalized moment control device includes a rotor assembly rotatably mounted within a rotor assembly housing. The rotor assembly includes an inertial element, typically an outer rim, which is fixedly coupled to a rotor shaft. The first end of the rotor shaft (the “fixed end” of the rotor shaft) is mounted within a first bore provided within the rotor assembly housing such that the first end can rotate, but is otherwise confined, relative to the rotor assembly housing. The second end of the rotor shaft (the “floating end” of the rotor shaft) is suspended within a second bore provided in the rotor assembly such that the second end is able to move axially and radially within certain limits, as well as rotate, relative to the rotor assembly housing. A bearing (e.g., a duplex-pair ball bearing) is disposed over each shaft end to facilitate rotation of the rotor assembly. If the momentum control device assumes the form of a reaction wheel, the rotor assembly housing may be directly mounted to the spacecraft. If the momentum control device assumes the form of a control moment gyroscope (“CMG”), the rotor assembly housing is rotatably disposed within an outer stator housing (e.g., a basering structure), which is, in turn, mounted to the spacecraft.

During operation of a momentum control device, a spin motor causes the rotor assembly to rotate about a spin axis. As the rotor assembly rotates, vibrations may be induced within the momentum control device due to static imbalance of the rotor assembly, dynamic imbalance of the rotor assembly, or structural imperfections in the components of the momentum control device (e.g., the spin bearings). When transmitted from the momentum control device to the spacecraft, such induced vibrations may result in emitted disturbances that can negatively impact the performance of the spacecraft; e.g., emitted disturbances can compromise the pointing accuracy of a telescope or other such instrument deployed aboard a satellite. Considerable vibratory forces may also be transmitted from the spacecraft to the rotor assembly during spacecraft launch. Therefore, to reduce emitted disturbances and to help protect a momentum control device during launch, a compliant or attenuating mounting device may be disposed between the momentum control device and the spacecraft's mounting interface. Such compliant or attenuating mounting devices range in effectiveness and complexity from relatively simple rubber mounting members, to passive dampers, to active isolation systems. However, due largely to their external disposition between the momentum control devices and the host spacecraft, such mounting devices tend to be undesirably bulky and weighty for deployment aboard a spacecraft.

Considering the foregoing, it is desirable to provide a rotor assembly for deployment within a momentum control device that reduces or eliminates the transmission of vibratory forces between the rotor assembly and the host spacecraft (or other host vehicle). Ideally, such a rotor assembly would include at least one damping member integral to the momentum control device to minimize the overall weight and envelope of the host momentum control device. Other desirable features and characteristics of embodiments of the present invention will become apparent from the subsequent Detailed Description and the appended Claims, taken in conjunction with the accompanying drawings and the foregoing Background.

### BRIEF SUMMARY

A rotor assembly is provided for deployment within a momentum control device including a rotor assembly housing. In one embodiment, the rotor assembly includes a rotor shaft rotatably mounted within the rotor assembly housing, a floating bearing cartridge disposed around a first end portion of the rotor shaft, and a radially-compliant damping member. The radially-compliant damping member is mechanically coupled between the floating bearing cartridge and the rotor assembly housing, as taken along an emitted disturbance path. The radially-compliant damping member reduces the transmission of vibratory forces from the floating bearing cartridge to the rotor assembly housing to reduce emitted disturbances during operation of the momentum control device.

### BRIEF DESCRIPTION OF THE DRAWINGS

At least one example of the present invention will hereinafter be described in conjunction with the following figures, wherein like numerals denote like elements, and:

FIG. 1 is a cross-sectional view of a reaction wheel in accordance with the teachings of prior art;

FIGS. 2 and 3 are exploded and cross-sectional views, respectively, of a rotor assembly (partially shown) including a radially-compliant damping member in accordance with a first exemplary embodiment;

FIG. 4 is an isometric view of a rotor assembly (partially shown) including a radially-compliant damping member in accordance with a second exemplary embodiment;

FIGS. 5 and 6 are top and cross-sectional views, respectively, of a radially-compliant damping member suitable for deployment within a rotor assembly in accordance with a third exemplary embodiment;

FIG. 7 is a top view of a radially-compliant damping member suitable for deployment within a rotor assembly in accordance with a fourth exemplary embodiment;

FIG. 8 is an isometric cutaway view of the damping member shown in FIG. 7 deployed within a rotor assembly (partially shown);

FIGS. 9 and 10 are side and top views, respectively, of a radially-compliant damping member suitable for deployment within a rotor assembly in accordance with a fifth exemplary embodiment;

FIG. 11 is an isometric cutaway view of the damping member shown in FIGS. 9 and 10 deployed within a rotor assembly (partially shown);

FIG. 12 is a cross-sectional view of a portion of a momentum control device including an elastomeric damping member in accordance with a sixth exemplary embodiment; and

FIG. 13 is an isometric view of the elastomeric damping member illustrated in FIG. 12.

### DETAILED DESCRIPTION

The following Detailed Description is merely exemplary in nature and is not intended to limit the invention or the application and uses of the invention. Furthermore, there is no intention to be bound by any theory presented in the preceding Background or the following Detailed Description. Although the following describes several exemplary embodiments of a rotor assembly including at least one radially-compliant damping member in the context of a reaction wheel, it will be appreciated that embodiments of the rotor assembly may be deployed in various other momentum control devices, including control moment gyroscopes.

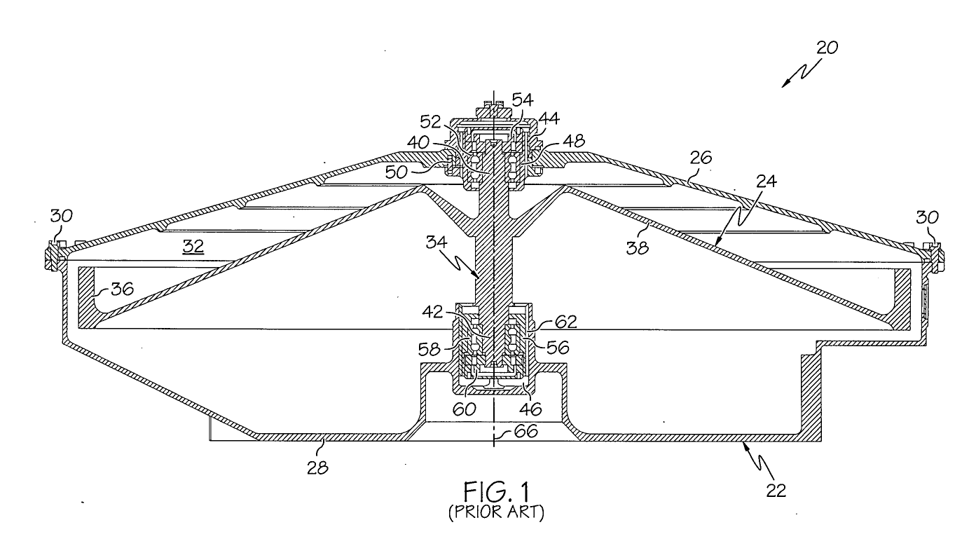

FIG. 1 is cross-sectional view of a reaction wheel 20 in accordance with the teachings of prior art. Reaction wheel 20 includes a rotor assembly housing 22 and a rotor assembly 24, which is rotatably mounted within rotor assembly housing 22. With reference to the orientation shown in FIG. 1, rotor assembly housing 22 includes an upper cover 26 and a lower casing 28, which is fixedly joined to upper cover 26 utilizing a plurality of threaded fasteners 30. Collectively, upper cover 26 and lower casing 28 define an internal cavity 32, which houses rotor assembly 24 and various other components of reaction wheel 20 that are conventionally known and not described herein in the interests of concision (e.g., a spin motor, a resolver or other rotational sensor, etc.). Rotor assembly 24 includes a rotor shaft 34 and a rotor rim 36, which is joined to rotor shaft 34 via a suspension web 38. Rotor shaft 34 has a fixed end portion 40 (the upper end portion of shaft 34 in the illustrated orientation) and a floating end portion 42 (the lower end portion of shaft 34 in the illustrated orientation). Fixed end portion 40 and floating end portion 42 are received within first and second annuli 44 and 46, respectively, provided within rotor assembly housing 22. A fixed bearing cartridge 48 is disposed around fixed end portion 40 of rotor shaft 34 and fixedly attached to upper cover 26 by a plurality of threaded fasteners 50 (only one of which is shown in FIG. 1). Fixed bearing cartridge 48 includes a spin bearing 52 (e.g., a duplex-pair ball bearing), which is disposed around fixed end portion 40 to facilitate the rotation of rotor shaft 34. A first nut 54 is threadably coupled to fixed end portion 40 and generally retains bearing 52 thereon. Similarly, a floating bearing cartridge 56 is disposed around floating end portion 42 of rotor shaft 34 and includes a spin bearing 58 (e.g., a duplex-pair ball bearing), which is retained on end portion 42 by a second nut 60. A floating cartridge sleeve 62 is disposed around floating bearing cartridge 56 and affixed to the inner structure of lower casing 28 defining annulus 46. Notably, sleeve 62 is spatially offset from floating bearing cartridge 56 by a small annular gap to permit floating bearing cartridge 56, and therefore floating end portion 42 of rotor shaft 34, to move radially and axially during operation of reaction wheel 20. Such freedom of movement helps to accommodate expansion and contraction that may occur between components (e.g., floating cartridge 56 and floating sleeve 62) over the operational temperature and vacuum range of reaction wheel 20.

During operation of reaction wheel 20, a spin motor (not shown) rotates rotor assembly 24 about a spin axis (represented in FIG. 1 by dashed line 66). As rotor assembly 24 rotates, induced vibrations may occur within reaction wheel 20 due to static imbalance of rotor assembly 24, dynamic imbalance of rotor assembly 24, or structural imperfections within spin bearings 52 and 58 or other components of reaction wheel 20. When transmitted from reaction wheel 20 to a host spacecraft, such induced vibrations may result in emitted disturbances that can negatively impact the performance of the spacecraft as previously described. Therefore, to reduce or eliminate emitted disturbances, and to further protect rotor assembly 24 from vibratory forces during spacecraft launch, the following describes several exemplary embodiments of a radially-compliant damping member that may be disposed around or adjacent to floating end portion 42 of rotor shaft 34, and an exemplary embodiment of an elastomeric damping member that may be disposed around fixed end portion 40 of rotor shaft 34, to minimize the transmission of vibratory forces between rotor assembly 24 and rotor assembly housing 22. Notably, each of the exemplary damping members described below is integral to the host momentum control device (e.g., reaction wheel 20, as modified by inclusion of an embodiment of the novel rotor assembly described below; or another momentum control device, such as a control moment gyroscope). Consequently, relative to conventional compliant or attenuating mounting systems disposed external to the host momentum control device, embodiments of the damping members achieve highly effective damping without significantly increasing the overall weight and envelope of the host momentum control device.

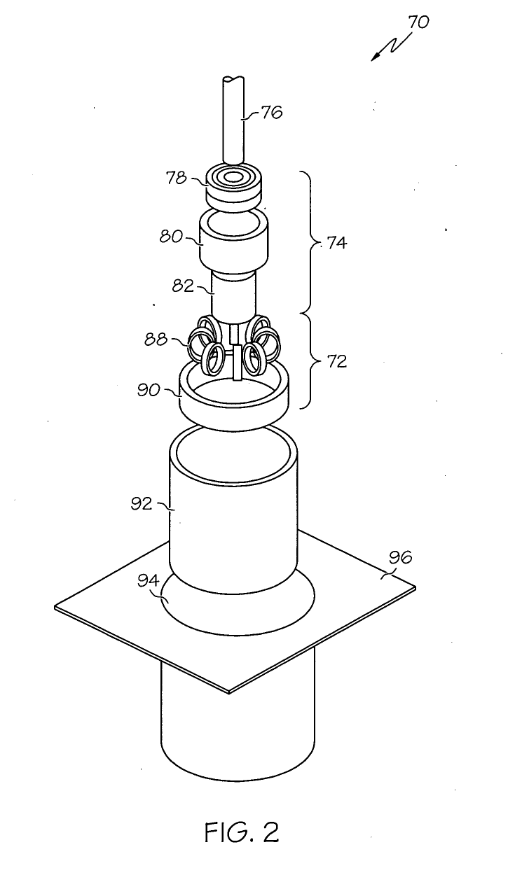

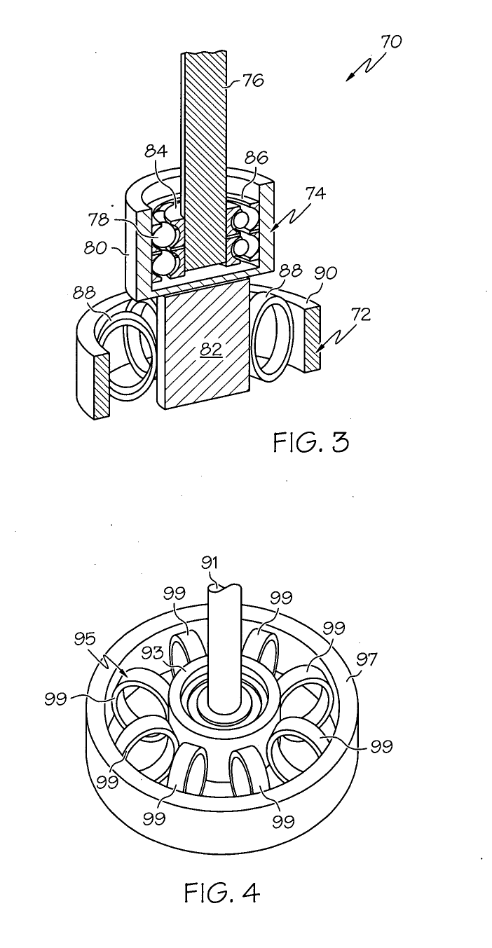

FIGS. 2 and 3 are exploded and cross-sectional views, respectively, of a rotor assembly 70 including a radially-compliant damping member 72 in accordance with a first exemplary embodiment. Rotor assembly 70 comprises a floating bearing cartridge 74 and a rotor shaft 76, only the floating end portion of which is shown. In the illustrated example, floating bearing cartridge 74 includes a spin bearing 78 (e.g., a duplex-pair ball bearing), a cartridge casing 80, and an axial cartridge extension 82. As shown most clearly in FIG. 3, when rotor assembly 70 is assembled, the floating end portion of rotor shaft 76 is received within bearing 78, which is, in turn, received within bearing cartridge casing 80. More specifically, the inner rings of bearing 78 (identified in FIG. 3 at 84) are fixedly coupled to the floating end portion of rotor shaft 76, and the outer rings of bearing 78 (identified in FIG. 3 at 86) are fixedly coupled to the inner surface of cartridge casing 80. As is well-known, a plurality of rolling elements (e.g., ball bearings, cylindrical rollers, or the like) is disposed between inner rings 84 and outer rings 86 of spin bearing 78. Axial cartridge extension 82 is fixedly coupled to the outer terminal end of cartridge casing 80 and extends axially therefrom. Axial cartridge extension 82 may be fixedly coupled to the cartridge casing 80 utilizing a one or more fasteners (not shown), utilizing a threaded interface, or utilizing another suitable coupling means (e.g., welding). Alternatively, axial cartridge extension 82 may be integrally formed with cartridge casing 80 as a unitary machined piece. Although axial cartridge extension 82 is illustrated as a solid shaft in FIGS. 2 and 3, axial cartridge extension 82 may assume other forms in alternative embodiments, such as a hollow shaft.

In the exemplary embodiment illustrated in FIGS. 2 and 3, radially-compliant damping member 72 includes a plurality of flexures 88 and a retaining ring 90. Flexures 88 are spaced around the inner circumferential surface of retaining ring 90 and extend radially inward therefrom. When rotor assembly 70 is assembled as shown in FIG. 3, flexures 88 are compressed between retaining ring 90 and axial cartridge extension 82 of floating bearing cartridge 74. Also, when rotor assembly 70 is assembled, retaining ring 90 is fixedly coupled to a mounting structure provided in a rotor assembly housing 96 (partially shown in FIG. 2). For example, and as indicated in FIG. 2, retaining ring 90 may be affixed to a tubular sleeve 92, which is, in turn, fixedly disposed within an annulus or bore 94 provided in rotor assembly housing 96. Flexures 88 may be formed from any suitable material including various metals and alloys, such as a beryllium copper alloy.

In the illustrated example, flexures 88 each assume the form of a substantially annular spring member. Flexures 88 are radially-compliant. Thus, flexures 88 help to reduce the transmission of vibratory forces from rotor shaft 76 to rotor assembly housing 96 and, therefore, the host spacecraft. Conversely, flexures 88 reduce the transmission of vibratory forces from rotor assembly housing 96 to rotor shaft 76 to help protect rotor assembly 70 from mechanical stressors during spacecraft launch. In addition, due to their annular shape, flexures 88 are able to roll between retaining ring 90 and floating bearing cartridge 74 to provide axial damping between floating bearing cartridge 74 and rotor assembly housing 96. Although not shown in FIGS. 2 and 3 for clarity, longitudinal channels may be provided in the outer circumferential surface of axial cartridge extension 82 and/or the inner circumferential surface of retaining ring 90 to guide the rolling movement of flexures 88 and accommodate flexure preload. Relative to conventional momentum control device, such as reaction wheel 20 (FIG. 1), the inner diameters of sleeve 92 and bore 94 are only slightly increased to accommodate radially-compliant damping member 72. Radially-compliant damping member 72 thus achieves effective isolation of the rotor assembly without adding significant bulk or weight to the host momentum control device.

There has thus been provided a first example of a rotor assembly including a radially-compliant damping member that reduces the transmission of vibratory forces from the floating bearing cartridge to the rotor assembly housing to reduce emitted disturbances during operation of the momentum control device. In the above-described exemplary embodiment, the radially-compliant damping member is disposed around a cartridge extension that projects axially from the floating bearing cartage casing; however, in alternative embodiments, the radially-compliant damping member may be disposed at various other locations, providing that the damping member is mechanically coupled between the floating bearing cartridge and the rotor assembly housing, as taken along an emitted disturbance path. Further emphasizing this point, FIG. 4 is an isometric view of the floating end portion of a rotor shaft 91, a floating bearing cartridge 93 disposed around the floating end portion of rotor shaft 91, and a radially-compliant damping member 95 disposed around floating bearing cartridge 93. Radially-compliant damping member 95 is substantially identical to radially-compliant damping member 72 (FIGS. 2 and 3); e.g., radially-complaint damping member 95 includes a retaining ring 97 and a plurality of flexures 99, which are spaced around the inner circumferential surface of retaining ring 97 and extend radially inward therefrom. Again, flexures 99 each assume the form of a substantially annular spring member; however, in this example, flexures 99 are compressed between retaining ring 97 and the casing of floating bearing cartridge 93. As noted above, flexures 99 are radially-compliant to provide radial damping between floating bearing cartridge 93 and the rotor assembly housing (e.g., rotor assembly housing 96 shown in FIG. 2), and flexures 99 are permitted to roll between retaining ring 97 and the casing of floating bearing cartridge 93 to provide axial damping between floating bearing cartridge 93 and the rotor assembly housing.

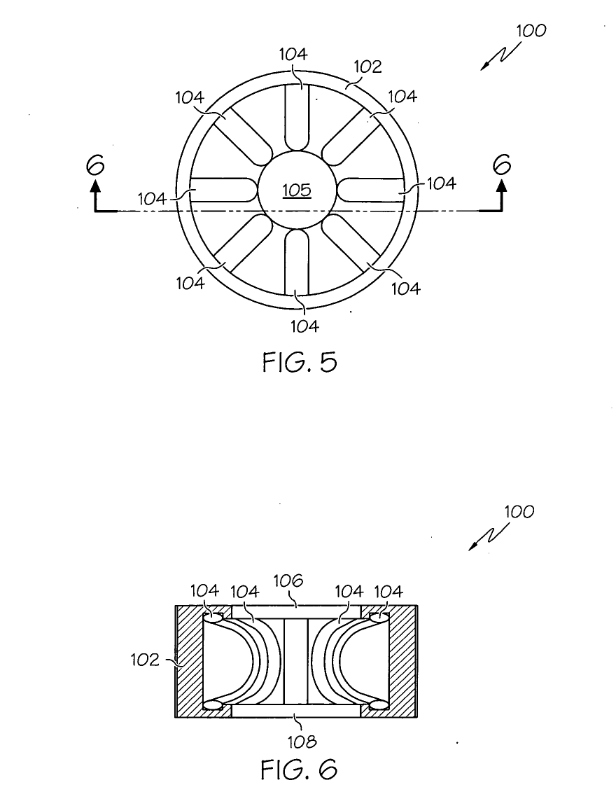

FIGS. 5 is a top view of a radially-compliant damping member 100 in accordance with a third exemplary embodiment, and FIG. 6 is a cross-sectional view of radially-compliant damping member 100 taken along line 6-6 (labeled in FIG. 5). In many respects, radially-compliant damping member 100 is similar to damping member 72 described above in conjunction with FIGS. 2 and 3 and to damping member 95 described above in conjunction with FIG. 4. For example, radially-compliant damping member 100 includes a retaining ring 102 and a plurality of flexures 104, which are spaced around the inner circumferential surface of retaining ring 102 and extend radially inward therefrom. When radially-compliant damping member 100 is deployed within a rotor assembly, flexures 104 may be compressed between retaining ring 102 and a floating bearing cartridge (represented generically in FIG. 5 by circle 105); e.g., flexures 104 may be compressed between retaining ring 102 and a cartridge extension of the floating bearing cartage as generally described above in conjunction with FIGS. 2 and 3, or flexures 104 may be compressed between retaining ring 102 and the casing of a floating bearing cartridge as generally described above in conjunction with FIG. 4. However, in contrast to the flexures of damping members 72 and 95, flexures 104 of radially-compliant damping member 100 assume the form of curved (e.g., C-shaped) spring members, which are generally captured by retaining ring 102. More specifically, and with reference to FIG. 6, retaining ring 102 is formed to have first and second flanges 106 and 108 that extend radially inward therefrom. Flanges 106 and 108 each include a lip that defines annular groove within the inner surface of retaining ring 102. The annular grooves defined by flanges 106 and 108 receive opposing ends of each flexure 104 to capture flexures 104 in an axially-compressed state such that flexures 104 bulge radially inward to contact the floating bearing cartridge. As shown in FIG. 6, each end of flexure 104 may have a bulbous shape to help retain flexures 104 within the annular grooves define by flanges 106 and 108.

As was the case with the flexures of damping member 72 and 95, flexures 104 of damping member 100 are radially-compliant. Thus, flexures 104 help to reduce the transmission of vibratory forces between a floating bearing cartridge disposed within or adjacent to damping member 100 (again, represented in FIG. 5 by circle 105) and the rotor assembly housing (not shown). However, in contrast to the flexures of damping member 72 and 95, flexures 104 of damping member 100 do not roll; instead, flexures 104 may frictionally slide relative to the floating bearing cartridge. The controlled sliding action of flexures 104 provides further axial damping between the floating bearing cartridge and the rotor assembly housing to further reduce emitted disturbances during the operation of the host momentum control device.

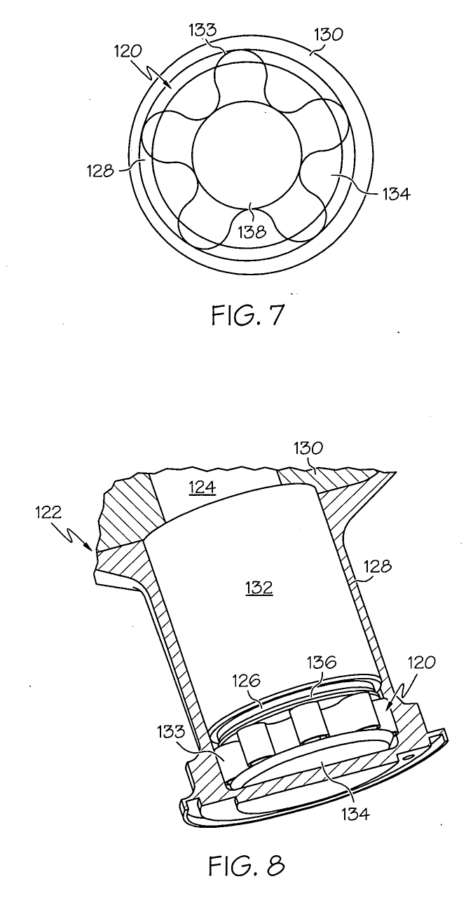

FIG. 7 is a top view of a radially-compliant damping member 120 suitable for deployment within a rotor assembly in accordance with a fourth exemplary embodiment, and FIG. 8 is an isometric cutaway view of damping member 120 deployed within a rotor assembly 122. Rotor assembly 122 is partially shown in FIG. 8 as including the floating end portion of a rotor shaft 124 and a floating bearing cartridge 126, which is disposed around the floating end portion of rotor shaft 124 to facilitate the rotational movement thereof. The floating end portion of rotor shaft 124 and floating bearing cartridge 126 are each received within an annulus or bore 128 provided within a rotor assembly housing 130 (only partially shown). A sleeve 132 is fixedly mounted within bore 128 and circumscribes floating bearing cartridge 126. Floating bearing cartridge 126 is separated from the inner walls of sleeve 132 by an annular gap to permit floating bearing cartridge, and thus rotor shaft 124, to move axially and radially during operation of the host momentum control device.

With continued reference to FIGS. 7 and 8, radially-compliant damping member 120 includes an annular spring member 133, a retaining base 134, a retaining cap 136 (identified in FIG. 8), and a central post 138 (identified in FIG. 7), which extends from retaining base 134 to retaining cap 136. Annular spring member 133 is disposed around central post 138 and between retaining cap 136 and retaining base 134. Retaining base 134, retaining cap 136 (FIG. 8), and central post 138 (FIG. 7) collectively form a rigid body that maintains annular spring member 133 in a desired position. Retaining cap 136 is fixedly attached to the terminal end of floating bearing cartridge 126 utilizing, for example, a plurality of fasteners (not shown), a threaded interface, or other suitable fastening means. Radially-compliant damping member 120 is thus disposed adjacent and axial to the terminal end of floating bearing cartridge 126.

In the exemplary embodiment illustrated in FIGS. 7 and 8, annular spring member 133 assumes the form of a multi-lobed ribbon. The major outer diameter of annular spring member 133 is greater than the outer diameters of retaining base 134, of retaining cap 136, and of floating bearing cartridge 126. Thus, as indicated in FIG. 8, annular spring member 133 extends radially beyond retaining base 134 and retaining cap 136 to contact the inner walls of bore 128. Annular spring member 133 consequently reduces the transmission of vibratory forces between floating bearing cartridge 126, and therefore rotor shaft 124, and rotor assembly housing 130. Annular spring member 133 is configured to slide axially relative to floating cartridge 126 within bore 128 to provide additional axial damping. If desired, the terminal end portions of annular spring member 133 may taper radially inward to prevent gouging of the inner walls of bore 128. As indicated above, annular spring member 133 may be formed from any suitable resilient material including various metals and alloys, such as a beryllium copper alloy.

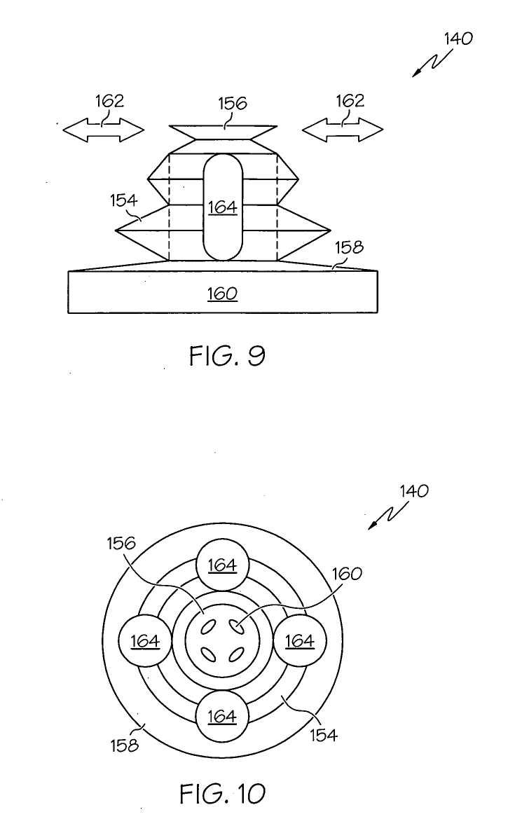

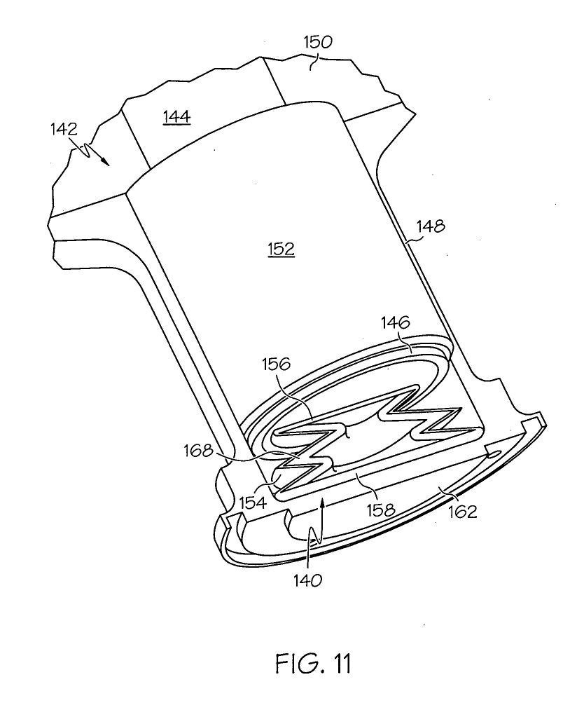

FIGS. 9 and 10 are side and top views, respectively, of a radially-compliant damping member 140 suitable for deployment within a rotor assembly in accordance with a fifth exemplary embodiment; and FIG. 11 is an isometric cutaway view of damping member 140 deployed within a rotor assembly 142. Rotor assembly 142 is partially shown in FIG. 11 as including the floating end portion of a rotor shaft 144 and a floating bearing cartridge 146 fixedly mounted around the floating end portion of rotor shaft 144. The floating end portion of rotor shaft 144 and floating bearing cartridge 146 are each received within an annulus or bore 148 provided within a rotor assembly housing 150 (only partially shown). A sleeve 152 is also fixedly mounted within bore 148 and circumscribes floating bearing cartridge 146. As noted above, floating bearing cartridge 146 is separated from the inner walls of sleeve 152 by a small annular gap.

In the exemplary embodiment illustrated in FIGS. 9-11, radially-compliant damping member 140 comprises an axially-compressible spring member, namely, a bellows 154 having an upper end portion 156 and a lower end portion 158. Bellows 154 is disposed adjacent and axial to floating bearing cartridge 146. As shown most clearly in FIG. 10, upper end portion 156 may include a plurality of apertures 160 therethrough, which permits bellows 154 to be attached to the terminal end of floating bearing cartridge 146 utilizing a plurality of non-illustrated fasteners. This example notwithstanding, bellows 154 may be joined to floating bearing cartridge 146 utilizing other coupling means, such as a threaded interface. In a similar manner, lower end portion 158 of bellows 154 may be fixedly mounted to rotor assembly housing 150, and specifically to the floor of bore 148 (illustrated generically in FIG. 9 at 160), utilizing a plurality of fasteners, a threaded interface, or any other suitable mounting means. When rotor assembly 142 is assembled, bellows 154 is axially compressed between floating bearing cartridge 146 and the floor of bore 148. As can be appreciated most easily in FIG. 9, bellows 154 tapers radially inward from lower end portion 158 to upper end portion 156; as a result, bellows 154 is permitted to move axially within bore 148 along with floating bearing cartridge 146 and rotor shaft 144 (indicated in FIG. 9 by arrows 162). Bellows 154 is thus generally permitted to move in all degrees of freedom and consequently provides both radial and axial damping to reduce the transmission of vibratory forces between floating bearing cartridge 146 (and therefore rotor shaft 144) and rotor assembly housing 150.

As indicated in FIGS. 9 and 10, one or more apertures 164 may be formed (e.g., laser cut) through the sidewalls of bellows 154 to tune the dampening characteristics of bellows 154 to a desired range of vibrational modes. To further increase the damping characteristics of bellows 154, an elastomeric coating (e.g., a polymeric coating, such as rubber) may be applied to one or more surfaces of bellows 154. For example, a conformal elastomeric coating may be applied over the inner surface of bellows 154 as generally shown in FIG. 11 at 168. In contrast, the main body of bellows 154 may be formed from a metal or alloy (e.g., a beryllium copper alloy). In alternative embodiments, bellows 154 may be closed such that the gaseous pressure within bellows 154 may differ from ambient.

It should thus be appreciated that there has been provided multiple exemplary embodiments of the a rotor assembly suitable for deployment within a momentum control device (e.g., a reaction wheel or a control moment gyroscope) that reduces or eliminates the transmission of vibratory forces between the rotor assembly and the host spacecraft (or other vehicle on which the momentum control device is deployed) to reduce emitted disturbances during operation of the momentum control device. It should further be appreciated that, in each of the foregoing exemplary embodiments, the radially-compliant damping member is integrated into to the momentum control device and consequently minimizes the overall weight and envelope of the momentum control device relative to conventional momentum control devices employing compliant and attenuation mounts.

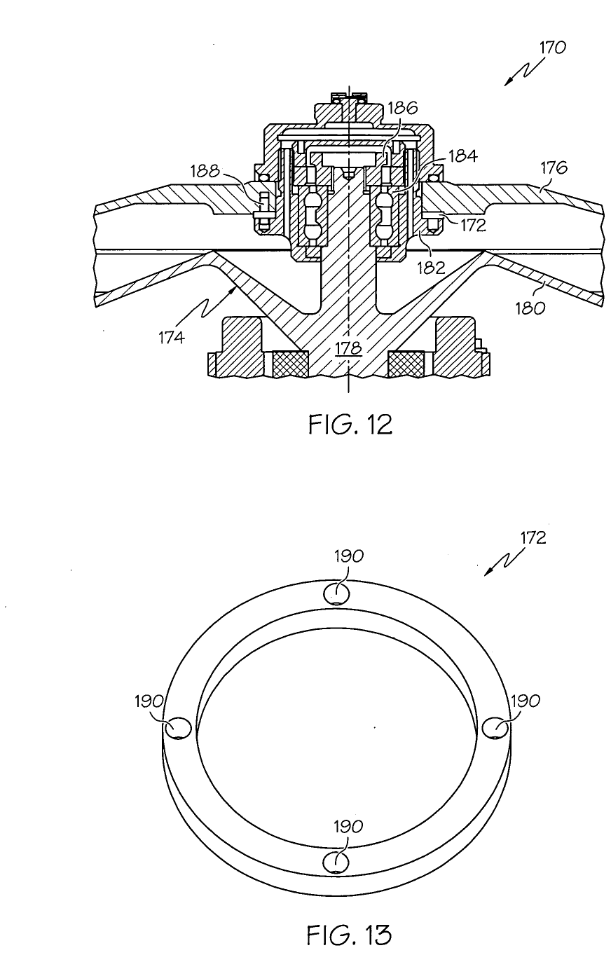

In each of the foregoing examples, the radially-compliant damping member was disposed around or adjacent to the floating end portion of a rotor shaft. These examples notwithstanding, alternative embodiments may include an elastomeric damping member disposed around the fixed end portion of the rotor shaft in addition to, or in lieu of, a radially-compliant damping member disposed around or adjacent to the floating end portion of the rotor shaft. Further illustrating this point, FIG. 12 is a cross-sectional view of a portion of a momentum control device 170 (e.g., a reaction wheel) including a elastomeric damping member 172 in accordance with a sixth exemplary embodiment; and FIG. 13 is an isometric view of elastomeric damping member 172. Momentum control device 170 includes a rotor assembly 174 rotatably mounted within a rotor assembly housing 176. Rotor assembly 174 comprises a rotor shaft 178 (partially shown), a suspension web 180 (partially shown), and a fixed bearing cartridge 182. Fixed bearing cartridge 182 includes a bearing 184 (e.g., a duplex-pair ball bearing), which is disposed around the fixed end portion of rotor shaft 178. Bearing 184 is generally retained around fixed end portion of rotor shaft 178 by a wing nut 186 threadably coupled to rotor shaft 178. The casing of fixed bearing cartridge 182 is fixedly mounted to an inner portion of rotor assembly housing 176 utilizing a plurality of fasteners 188 (only one of which is shown in FIG. 12). In the illustrated example, elastomeric damping member 172 assumes the form of an annular elastomeric body, which is disposed between the casing of fixed bearing cartridge 182 and the inner portion of rotor assembly 174. As shown in FIG. 13, elastomeric damping member 172 may include a plurality of apertures 190 therethrough to accommodate fasteners 188. Due to its elastomeric properties, damping member 172 helps to reduce the transmission of vibratory forces between fixed bearing cartridge 182 and rotor assembly housing 176 to reduce emitted disturbances during operation of momentum control device 170. Although, in the illustrated example, elastomeric damping member 172 assumes a relatively simple annular form, the particular geometric form of damping member 172 will inevitably vary amongst different embodiment; for example, in certain embodiments, elastomeric damping member 172 may include a raised inner portion (e.g., a raised inner collar) that extends axially from the main body of damping member 172 to contact fixed bearing cartridge 182 or an inner surface of rotor assembly housing 176.

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention. It being understood that various changes may be made in the function and arrangement of elements described in an exemplary embodiment without departing from the scope of the invention as set-forth in the appended claims.

What is claimed is:

1. A rotor assembly for deployment within a momentum control device including a rotor assembly housing, the rotor assembly comprising:
a rotor shaft rotatably mounted within the rotor assembly housing;
a floating bearing cartridge disposed around a first end portion of the rotor shaft; and
a radially-compliant damping member mechanically coupled between the floating bearing cartridge and the rotor assembly housing, as taken along an emitted disturbance path, the radially-compliant damping member reducing the transmission of vibratory forces from the floating bearing cartridge to the rotor assembly housing to reduce emitted disturbances during operation of the momentum control device.

2. A rotor assembly according to claim 1 wherein the radially-compliant damping member is disposed around the floating bearing cartridge.

3. A rotor assembly according to claim 1 wherein the radially-compliant damping member resides adjacent and axial to an end portion of the floating bearing cartridge.

4. A rotor assembly according to claim 3 wherein the floating bearing cartridge comprises:
a bearing, comprising:
an inner ring fixedly coupled to the first end portion of the shaft;
an outer ring generally circumscribing the inner ring; and
a plurality of rolling elements disposed between the inner ring and the outer ring; and
an axial cartridge extension fixedly coupled to the outer ring, the radially-compliant damping member disposed around the axial cartridge extension.

5. A rotor assembly according to claim 1 wherein the rotor assembly housing comprises a bore configured to receive the first end portion of the rotor shaft therein, the floating bearing cartridge disposed within the bore and separated therefrom by an annular gap.

6. A rotor assembly according to claim 5 wherein the radially-compliant damping member is disposed within the bore and contacts an inner surface thereof.

7. A rotor assembly according to claim 1 wherein the radially-compliant damping member comprises an axially-compressible spring member having a first end portion fixedly coupled to the floating bearing cartridge and having a second end portion fixedly coupled to the rotor assembly housing.

8. A rotor assembly according to claim 7 wherein the axially-compressible spring member comprises a bellows.

9. A rotor assembly according to claim 8 wherein the bellows comprises:
an axially-compressible body coupled between the floating bearing cartridge and the rotor assembly housing; and
a polymeric coating conformal with a surface of the main body.

10. A rotor assembly according to claim 7 wherein the bellows tapers radially inward.

11. A rotor assembly according to claim 1 wherein the radially-compliant damping member comprises:
a retaining ring fixedly coupled to the rotor assembly housing; and
a plurality of flexures compressed between the retaining ring and the floating bearing cartridge.

12. A rotor assembly according to claim 11 wherein the plurality of flexures is dispersed around an inner circumference of the retaining ring and extends radially inward therefrom.

13. A rotor assembly according to claim 12 wherein the plurality of flexures comprises a plurality of substantially annular spring members configured to roll between the retaining ring and the floating bearing cartridge to provide axial damping between the floating bearing cartridge and the rotor assembly housing.

14. A rotor assembly according to claim 11 wherein the plurality of flexures comprises a plurality of curved spring members generally captured by the retaining ring, the plurality of curved spring members configured to slide relative to the floating bearing cartridge to provide axial damping between the floating bearing cartridge and the rotor assembly housing.

15. A rotor assembly according to claim 1 wherein the radially-compliant damping member comprises an annular spring member disposed around the floating bearing cartridge.

16. A rotor assembly according to claim 15 wherein the annular spring member comprises a ribbon having a multi-lobed geometry.

17. A rotor assembly according to claim 1 further comprising:
a fixed bearing cartridge disposed around a second end portion of the rotor shaft; and
an annular elastomeric member disposed between the fixed bearing cartridge and the rotor assembly housing.

18. A rotor assembly according to claim 17 further comprising a plurality of fasteners fixedly coupling the fixed bearing cartridge to the rotor assembly housing, the annular elastomeric member including a plurality of apertures therethrough each receiving a different one of the plurality of fasteners.

19. A rotor assembly for deployment within a momentum control device including a rotor assembly housing, the rotor assembly comprising:
a rotor shaft rotatably mounted within the rotor assembly housing, the rotor shaft having a fixed end portion and a floating end portion;
a floating bearing cartridge disposed around the floating end portion of the rotor shaft; and
a radially-compliant damping member mechanically coupled between the floating bearing cartridge and the rotor assembly housing, as taken along an emitted disturbance path, the radially-compliant damping member reducing the transmission of vibratory forces from the floating bearing cartridge to the rotor assembly housing to reduce emitted disturbances during operation of the momentum control device;
wherein the radially-compliant damping member comprises at least one of the group consisting of: (i) a plurality of curved flexures, (ii) a multi-lobed ribbon, and (iii) a bellows.

20. A rotor assembly for deployment within a momentum control device including a rotor assembly housing, the rotor assembly comprising:
a rotor shaft rotatably mounted within the rotor assembly housing, the rotor shaft having a fixed end portion and a floating end portion;
a floating bearing cartridge disposed around the floating end portion of the rotor shaft;
a fixed bearing cartridge disposed around the fixed end portion of the rotor shaft;
an annular elastomeric member disposed between the fixed bearing cartridge and the rotor assembly housing; and
a radially-compliant damping member disposed adjacent the floating bearing cartridge, the radially-compliant damping member mechanically coupled between the floating bearing cartridge and the rotor assembly housing, as taken along an emitted disturbance path, the radially-compliant damping member cooperating with the annular elastomeric member to reduce the transmission of vibratory forces from the floating bearing cartridge to the rotor assembly housing to reduce emitted disturbances during operation of the momentum control device.
